(19) United States
(12) Patent Application Publication
(10) Pub. No.: US 2007/0090156 A1
(43) Pub. Date: Apr. 26, 2007

(54) Method for forming solder contacts on mounted substrates

(76) Inventors: Lakshmi N. Ramanathan, Chandler, AZ (US); Terry K. Daly, Gilbert, AZ (US); Jason R. Fender, Chandler, AZ (US)

Correspondence Address: INGRASSIA, FISHER & LORENZ, P.C., 7150 E. CAMELBACK ROAD, SUITE 325, SCOTTSDALE, AZ, 85251, US

(21) Appl. No.: 11/258,650

(22) Filed: Oct. 25, 2005

(51) Int. Cl. A47J 36/02

(52) U.S. Cl. 228/101

(57) ABSTRACT

A method is provided for forming a microelectronic assembly. A semiconductor substrate having a first thickness is mounted to a support substrate with a low temperature adhesive. The semiconductor substrate is thinned from the first thickness to a second thickness. At least one contact formation is formed on the semiconductor substrate, and high energy electromagnetic radiation is directed onto the at least one contact formation to reflow the at least one contact formation.

### FIELD OF THE INVENTION

The present invention generally relates to a method for fabricating a microelectronic assembly, and more particularly relates to a method for reflowing contact formations on mounted substrates.

### BACKGROUND OF THE INVENTION

Integrated circuit devices are formed on semiconductor substrates, or wafers. The wafers are then sawed into microelectronic dies, or semiconductor chips, with each die carrying a respective integrated circuit. Each semiconductor chip is mounted to a package, or carrier, substrate using either wirebonding or “flip-chip” connections. The packaged chip is then mounted to a circuit board, or motherboard, before being installed in an electronic system.

The fabrication of the integrated circuits involves numerous processing steps as well as the formation of various devices on the semiconductor substrate. Often, one of the processing steps includes reducing the thickness of the semiconductor substrate, or “thinning” the substrate, to less than 100 microns. After the substrate is thinned, it may be mounted to a stiffener, or support substrate, to add mechanical strength to the substrate and prevent damage during subsequent processing steps. A low temperature, organic adhesive is often used to mount the semiconductor substrate to the support substrate. Typically, the organic adhesive has a softening temperature below 160° C.

Flip chip interconnections are made by depositing tiny solder balls on bond pads on the chip which are then connected to the package substrate. The solder interconnections allow thermal and electrical connections to be made to the integrated circuits. After forming the solder bumps, such as by electroplating or screen printing, it is necessary to reflow the solder bumps to form the appropriate alloy that forms the interconnections. Traditionally, reflow involves placing the entire substrate in an oven to raise the temperature of the contact formations above their melting temperatures, which are typically above 183° C. The oven is usually heated to a temperature 30-40° C. greater than the melting point of the solder being alloyed.

Therefore, if a conventional oven is used, the entire substrate will be subjected to temperatures well above the softening temperature of the organic adhesive, and the support substrate may become at least partially disconnected from the semiconductor substrate. As a result, the mechanical strength of the substrate may be adversely affected which increases the likelihood that the substrate will be damaged during subsequent processing and handling.

Accordingly, it is desirable to reflow the contact formations without increasing the temperature of the assembly above the softening temperature of the adhesive. Furthermore, other desirable features and characteristics of the present invention will become apparent from the subsequent detailed description and the appended claims, taken in conjunction with the accompanying drawings and the foregoing technical field and background.

### BRIEF DESCRIPTION OF THE DRAWINGS

The present invention will hereinafter be described in conjunction with the following drawings, wherein like numerals denote like elements, and

FIG. 1 is a cross-sectional side view of a semiconductor substrate;

FIG. 2 is a cross-sectional side view of the semiconductor substrate of FIG. 1 mounted to a support substrate;

FIG. 3 is a cross-sectional side view of the semiconductor substrate of FIG.2 undergoing a thinning process;

FIG. 4 is a cross-sectional side view of the semiconductor substrate of FIG. 3 after a via has been formed therethrough;

FIG. 5 is a cross-sectional side view of the semiconductor substrate of FIG. 4 with a conductive layer formed thereon;

FIG. 6 is a cross-sectional side view of the semiconductor substrate of FIG. 5 with a passivation layer formed over the conductive layer;

FIG. 7 is a cross-sectional side view of the semiconductor substrate of FIG. 6 after the passivation layer has been selectively etched;

FIGS. 8 is a cross-sectional side view of the semiconductor substrate of FIG. 7 with a photoresist layer formed over the passivation layer;

FIG. 9 is a cross-sectional side view of the semiconductor substrate of FIG. 8 with a contact formation formed within the photoresist layer;

FIG. 10 is a cross-sectional side view of the semiconductor substrate of FIG. 9 after the photoresist layer has been removed;

FIG. 11 is a cross-sectional side view of the semiconductor substrate of FIG. 10 after the conductive layer has been selectively etched;

FIG. 12 is a cross-sectional side view of the semiconductor substrate of FIG. 11 illustrating the contact formation undergoing a reflow process;

FIG. 13 is an expanded side view of the semiconductor substrate of FIG. 12 illustrating the substrate on a substrate support during the reflow process;

FIG. 14 is a cross-sectional side view of the semiconductor substrate of FIG. 12 after the contact formation has undergone the reflow process;

FIG. 15 is a cross-sectional side view of the semiconductor substrate of FIG. 14 with an additional passivation layer formed thereon;

FIG. 16 is a cross-sectional side view of the semiconductor substrate of FIG. 15 with an additional photoresist layer formed thereon;

FIG. 17 is a cross-sectional side view of the semiconductor substrate of FIG. 16 after the additional passivation layer has been selectively removed; and

FIG. 18 is a cross-sectional side view of the semiconductor substrate of FIG. 17 illustrating the support substrate being demounted therefrom.

### DETAILED DESCRIPTION OF THE INVENTION

The following detailed description is merely exemplary in nature and is not intended to limit the invention or application and uses of the invention. Furthermore, there is no intention to be bound by any expressed or implied theory presented in the preceding technical field, background, brief summary, or the following detailed description. It should also be noted that FIGS. 1-18 are merely illustrative and may not be drawn to scale.

FIGS. 1-18 illustrate a method for forming a microelectronic assembly, according to one embodiment of the invention. Referring to FIG. 1, there is illustrated a semiconductor substrate 20. The semiconductor substrate 20 is made of a semiconductor material, such as gallium arsenide (GaAs), gallium nitride (GaN), or silicon (Si). The substrate 20 has a front side 22, or upper surface, a back side 24, or lower surface, and an initial thickness 26 of, for example, between 600 and 1000 microns. Although only a portion of the semiconductor substrate 20 is illustrated, it should be understood that the substrate 20 may be a semiconductor wafer with a diameter of, for example, 150, 200, or 300 millimeters. Additionally, although not specifically illustrated, the substrate 20 may include a plurality of microelectronic devices, such as integrated circuits having a plurality of transistors, capacitors, etc., formed on the front side 22 thereof. The integrated circuits may be divided amongst multiple dies, or “dice,” on the substrate 20, as is commonly understood in the art. Furthermore, although the following process steps may be shown as being performed on only a small portion of the substrate 20, it should be understood that each of the steps may be performed on substantially the entire substrate 20, or multiple dice, simultaneously.

The semiconductor substrate 20 is first mounted to a support substrate 28, or stiffener, as shown in FIG. 2 with the semiconductor substrate 20 upside down relative to FIG. 1. The support substrate 28 is thus connected to the front side 22 of the semiconductor substrate 20 and has a thickness 30 of, for example, between 250 and 500 microns. The support substrate 28 is made of a material, such as, for example, sapphire or quartz, which is chemically inert with the materials used to deprocess the semiconductor substrate 20. Although not specifically illustrated, the semiconductor substrate 20 is mounted to the support substrate 28 using a low temperature, organic adhesive which may have a softening temperature below 160° C. In one embodiment, the adhesive has a softening temperature of approximately 150° C.

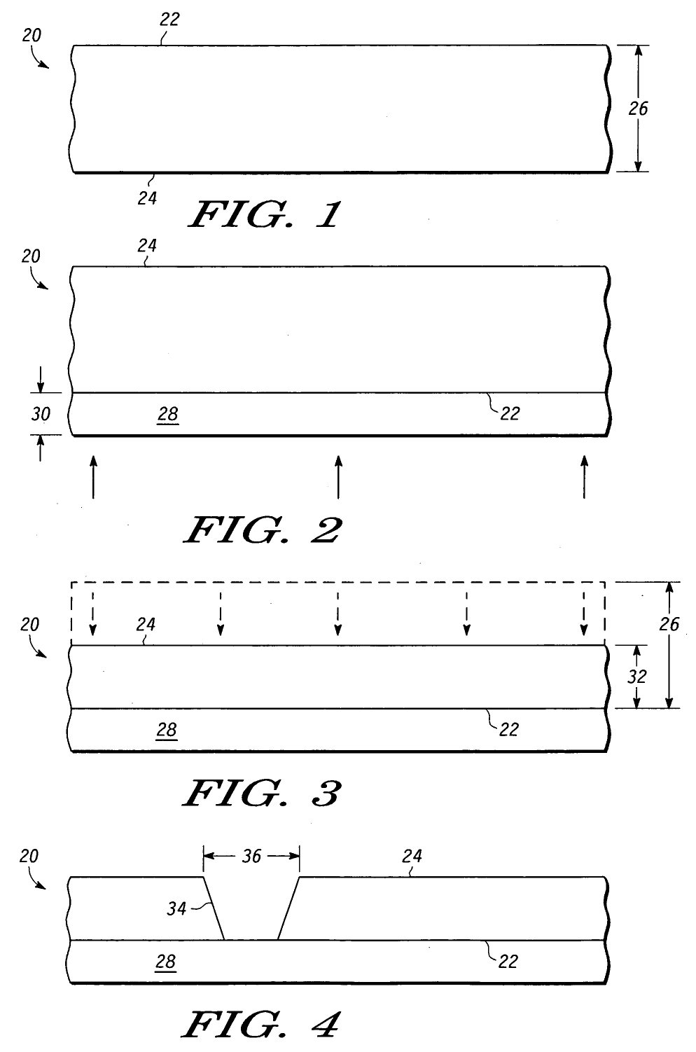

As illustrated in FIG. 3, the semiconductor substrate 20 is then “thinned” from the back side 24 to reduce the thickness of the substrate 20 from the initial thickness 26 to a thinned thickness 32. The thinning process may be performed using a chemical mechanical polishing (CMP) process or wet chemical etch, and the thinned thickness 32 may be, for example, less than 100 microns, such as between 25 and 75 microns.

Referring to FIG. 4, the back side 24 of the semiconductor substrate 20 then undergoes a photoresist patterning and etching process to form vias 34 on the semiconductor substrate 20. The vias 34 may have a width 36 of, for example, between 35 and 65 microns and may penetrate the entire thickness of the substrate 20 to expose the microelectronic devices formed on the front side 22 of the substrate 20.

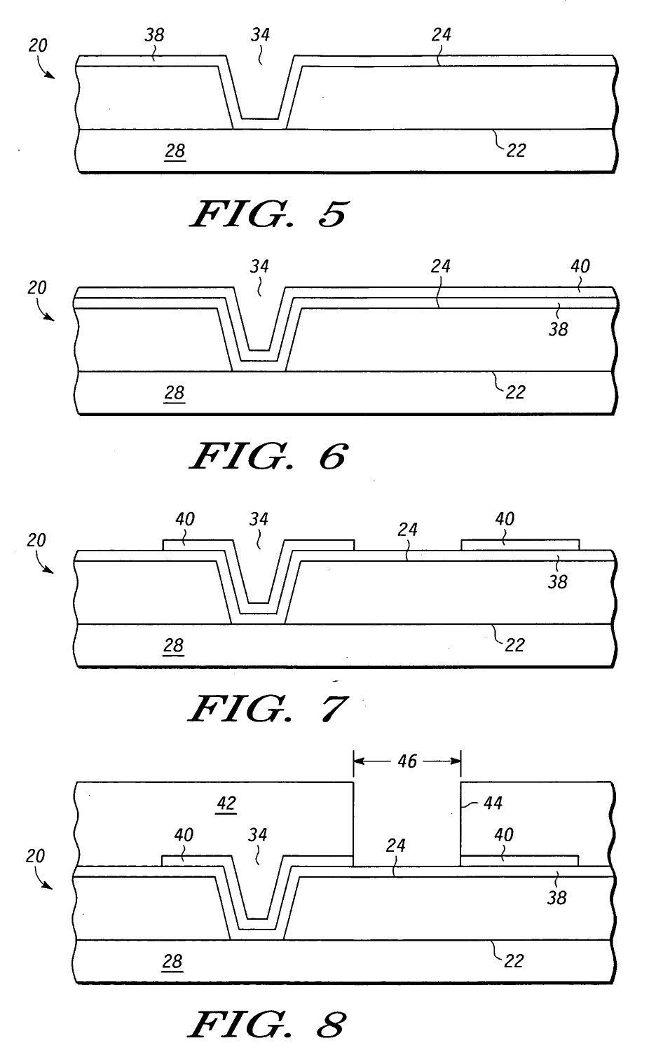

A conductive layer 38 and a passivation layer 40 are then successively formed on the back side 24 of the substrate 20, as illustrated in FIGS. 5 and 6, respectively. Although not illustrated in detail, the conductive layer 38 may include a titanium layer sputtered to a thickness of approximately 2000 angstroms on the back side 24 of the substrate 20, a first gold layer sputtered on the titanium layer to a thickness of approximately 6000 angstroms, and a second gold layer plated on the first gold layer to a thickness of approximately 2.5 microns. The conductive layer 38 may completely cover the back side 24 of the substrate 20, including the vias 34. In subsequent processing steps, the conductive layer 38 may serve as the electrical bus layer used to deposit a bond pad and solder material. The passivation layer 40 may be made of silicon nitride (SiN) and formed using, for example, sputtering or chemical vapor deposition (CVD) and have a thickness of between 1 and 2 microns. Although not specifically illustrated, it should be understood that the conductive layer 38 may contact the microelectronic devices formed on the front side 22 of the substrate 20.

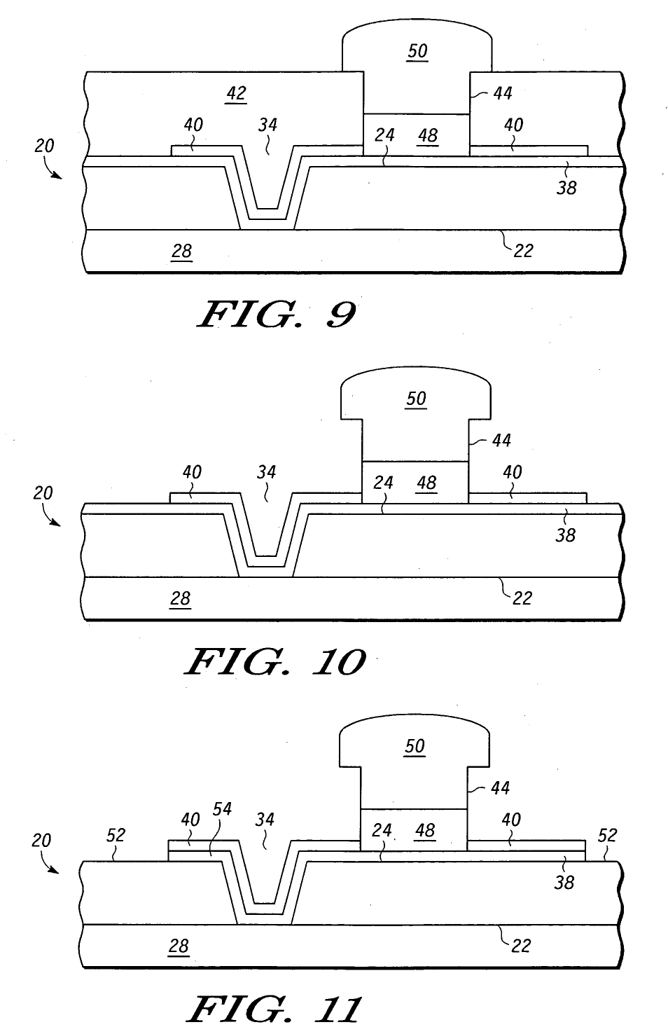

The passivation layer 40 may then be selectively etched, and subsequently, an additional layer of photoresist 42 may be formed thereon with a solder bump hole 44 formed therein over an etched portion of the passivation layer 40, as shown in FIGS. 7 and 8. The photoresist layer 42 may have a thickness of between 7 and 75 microns, and the solder bump hole 44 may have a width 46 of, for example, between 50 and 100 microns.

As illustrated in FIG. 9, a solder bump pad 48 and a solder bump 50, or contact formation, are then formed in the solder bump hole 44 in the photoresist layer 42. The solder bump pad 48 may be formed on the exposed portion of the conductive layer 38 using sputtering or plating and may be made of, for example, nickel (Ni), copper (Cu), or chromium copper (CrCu). The solder bump 50 may be formed on the solder bump pad 48 using electroplating, screen printing, or evaporation and may be made of, for example, lead-free solders, such as tin copper (SnCu), or lead-containing solders, such as high-Pb or eutectic lead tin (PbSn) alloys. The solder bump 50 may have a melting temperature between, for example, 220 and 350° C. After the formation of solder bump 50, the photoresist layer 42 is removed using, for example, a wet stripping process using various solvents known in the art, as shown in FIG. 10.

Referring to FIG. 11, the conductive layer 38 may then be selectively etched from particular regions 52 on the back side 24 of the substrate 20 known as “streets,” as in commonly understood in the art, to form a plurality of conductors 54. Each conductor 54 may electrically connect a respective microelectronic device on the front side 22 of the substrate 20 to a solder bump 50 through one of the solder bump pads 48 and be electrically disconnected from the other conductors 54.

The solder bumps 50 then undergo a reflow process by directing high energy electromagnetic radiation 56, or laser light, onto the solder bumps 50 for a very brief period of time, such as between a millisecond and a few seconds. In one embodiment, the period of time may be between 1 millisecond and 3 seconds or less than 0.5 seconds. The high energy electromagnetic radiation may be laser light from, for example, a Yttrium Aluminum Garnet (YAG) laser with a wavelength of, for example, 1024 nanometers operated on either a continuous or pulsed mode. The laser light may have, for example, between 10 and 100 watts of power and deliver, for example, between 0.125 and 0.5 Joules of energy into each solder bump.

As will be appreciated by one skilled in the art, the laser light 56 may heat the solder bumps 50 above the melting temperature of the respective material in the solder 50. However, because the laser light 56 is directed onto the solder bumps 50 for such a short period of time, the remainder of the substrate 20, the support substrate 28, and in particular the adhesive holding the semiconductor substrate 20 to the support substrate 28 may remain at a temperature that is below approximately 150° C. (i.e., the softening temperature of the adhesive). Therefore, the solder bumps 50 may be brought to reflow without the danger of the support substrate 28 becoming disconnected from the semiconductor substrate 20 and thus mechanically weaken the substrate 20.

As illustrated specifically in FIG. 13, the reflow process using the laser light 56 may be performed while the substrate 20 is positioned on a substrate support 58, or wafer chuck, which may include a refrigeration apparatus to further ensure that the temperatures endured by the semiconductor substrate 20 do not approach the melting temperature of the adhesive. Additionally, a reticle 60, or mask, as is commonly understood in the art, may be positioned above the semiconductor substrate 20 so that a large band of laser light 56 may be carefully directed therethrough, and multiple solder bumps 50 may be heated simultaneously.

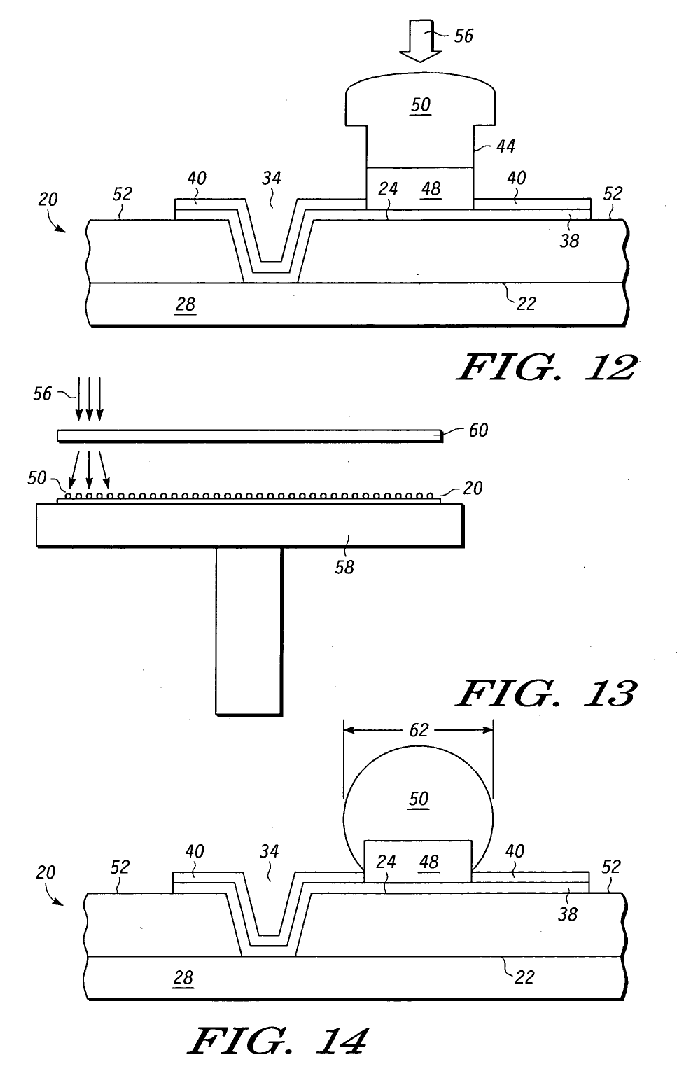

FIG. 14 illustrates one of the solder bumps 50 after the reflow process. As shown, after reflow the solder bump 50 may be substantially spherical in shape with a diameter 62 of, for example, between 110 and 150 microns.

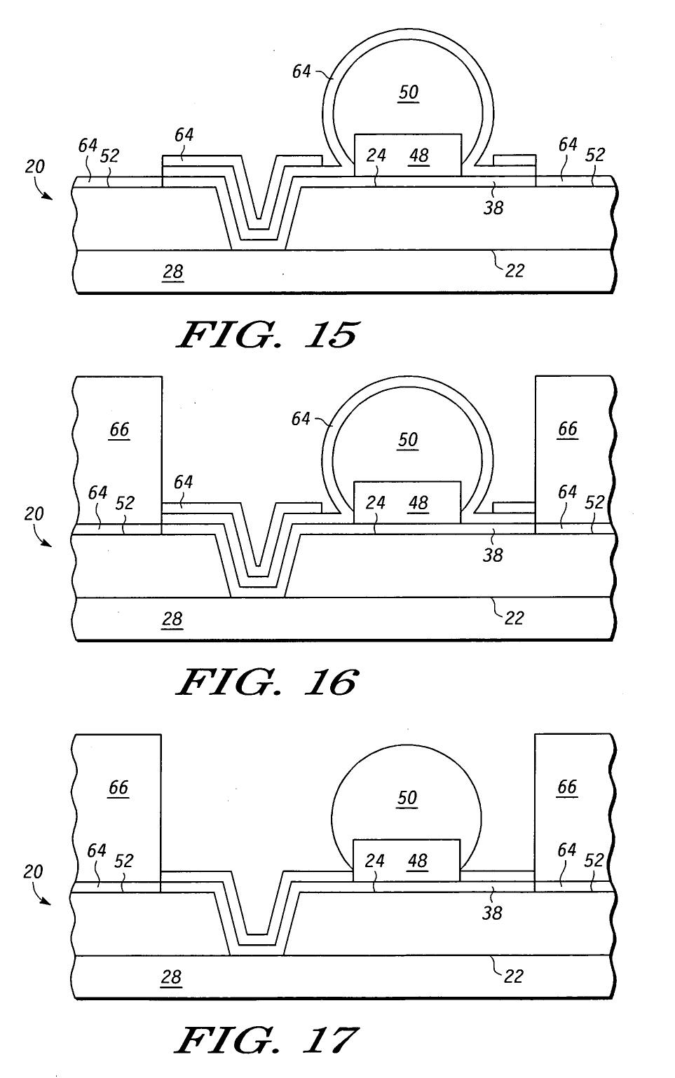

Referring to FIG. 15, a second passivation layer 64, similar to the passivation layer 40 illustrated in FIG. 6, may then be formed over the semiconductor substrate 20 including the solder bump 50. As shown, the second passivation layer 64 may cover the streets 52 on the back side 24. A final photoresist layer 66 may then be formed on the substrate 20 and selectively etched to only cover the portions of the second passivation layer 64 that cover the streets 52, as illustrated in FIG. 16. As shown in FIG. 17, the second passivation layer 64 may then be removed from the solder bump 50 using a selective etching process. The final photoresist layer 66 may also be removed at a fashion similar to that described above.

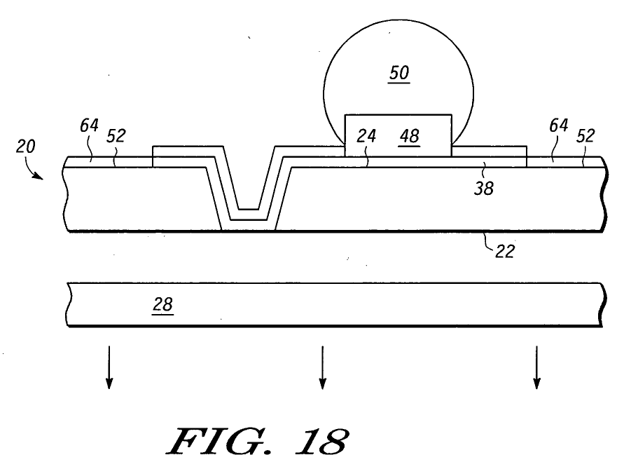

As shown in FIG. 18, the support substrate 28 may then be demounted from the semiconductor substrate 20. As will be appreciated by one skilled in the art, the low temperature, organic adhesive between the semiconductor substrate 20 and the support substrate 28 may be dissolved in specialized solvents held between, for example, 100 and 150° C.

After final processing steps, the substrate 20 may be sawed into individual microelectronic dice, or semiconductor chips, packaged, and installed in various electronic or computing systems.

One advantage of the method described above is that the contact formations may be heated to reflow while maintaining the temperature of the remainder of the substrate below the softening temperature of the adhesive between the substrate and the stiffener. Therefore, contact formations may be formed and reflown on thinned substrates while maintaining sufficient mechanical strength of the substrate. Another advantage is that because of the high temperatures created by the laser light, the contact formations may be brought to reflow very quickly thereby reducing the necessary process time for the semiconductor chips.

The invention provides a method for forming a microelectronic assembly. A semiconductor substrate having a first thickness is mounted to a support substrate with a low temperature adhesive. The semiconductor substrate is thinned from the first thickness to a second thickness. At least one contact formation is formed on the semiconductor substrate, and high energy electromagnetic radiation is directed onto the at least one contact formation to reflow the at least one contact formation.

The adhesive may have a softening temperature below 160° C. The adhesive may be an organic adhesive. The semiconductor substrate may include a plurality of microelectronic devices formed on a front side thereof.

The method may also include forming a plurality of contact formations on a back side of the semiconductor substrate and forming a plurality of conductors from at least one of the microelectronic devices on the front side of the substrate to the back side of the semiconductor substrate. Each of the contact formations may be electrically connected to a respective one of the conductors.

The high energy electromagnetic radiation may be laser light. The plurality of contact formations may be solder bumps having a melting temperature above 220° C. The second thickness of the semiconductor substrate may be less than 100 microns. The semiconductor substrate may include at least one of gallium arsenide, gallium nitride, and silicon. The support substrate may include at least one of sapphire and quartz.

The method may also include demounting the semiconductor substrate from the support substrate.

The invention also provides a method for forming a microelectronic assembly. A semiconductor substrate, having a first thickness, may be mounted to a support substrate with a low temperature adhesive having a softening temperature below 160° C. The semiconductor substrate may be thinned from the first thickness to a second thickness. The second thickness may be less than 100 microns. A plurality of solder bumps may be formed on the semiconductor substrate having a melting temperature above 220° C. High energy electromagnetic radiation may be directed onto at least one of the contact formations for a period of time sufficient to raise the temperature of the at least one of the contact formations above 220° C. and maintain the temperature of at least a portion of the low temperature adhesive below 160° C.

The high energy electromagnetic radiation may be laser light. The period of time may be less than 0.5 seconds.

The semiconductor substrate may include a plurality of microelectronic devices formed on a front side thereof. The method may also include forming a plurality of conductors from the microelectronic devices on the front side of the semiconductor substrate to a back side of the semiconductor substrate. The plurality of solder bumps may be formed on the backside of the semiconductor substrate and each of the solder bumps may be electrically connected to a respective one of the conductors.

The semiconductor substrate may include at least one of gallium arsenide, gallium nitride, and silicon. The support substrate may include at least one of sapphire and quartz.

The invention further provides a method for forming a microelectronic assembly. A semiconductor substrate may be mounted to a support substrate with a low temperature adhesive having a softening temperature below 160° C. The semiconductor substrate may have a top side, a back side, a first thickness, and a plurality of microelectronic devices formed on the top side. The top side of the semiconductor substrate may be adjacent to the support substrate. The semiconductor substrate may be thinned to a second thickness. The second thickness may be less than 100 microns. A plurality of vias may be formed through the back side of the semiconductor substrate to the microelectronic devices on the front side of the substrate. A plurality of conductors may be formed from the microelectronic devices on the front side of the semiconductor substrate through the vias to the back side of the semiconductor substrate. A plurality of solder bumps may be formed on the back side of the semiconductor substrate. The plurality of solder bumps may each be electrically connected to a respective microelectronic device on the front side of the semiconductor substrate through a respective conductor. The solder bumps may have a melting temperature above 220° C. Laser light may be directed onto at least one of the solder bumps for a period of time less than 0.5 seconds to reflow the at least one of the solder bumps. The semiconductor substrate may be demounted from the support substrate.

The laser light may raise the temperature of the at least one of the solder bumps above 220° C. and maintain the temperature of at least a portion of the low temperature adhesive below 160° C. The solder bumps may include a lead-free solder material.

The method may also include placing the semiconductor substrate on a refrigerated substrate support prior to said direction of laser light. The laser light may be directed onto a plurality of the solder bumps simultaneously.

The semiconductor substrate may include at least one of gallium arsenide, gallium nitride, and silicon. The support substrate may include at least one of sapphire and quartz.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method for forming a microelectronic assembly, comprising:
mounting a semiconductor substrate having a first thickness to a support substrate with a low temperature adhesive;
thinning the semiconductor substrate from the first thickness to a second thickness;
forming at least one contact formation on the semiconductor substrate; and
directing high energy electromagnetic radiation onto the at least one contact formation to reflow the at least one of the contact formation.

2. The method of claim 1, wherein the adhesive has a softening temperature below 160° C.

3. The method of claim 2, wherein the adhesive is an organic adhesive.

4. The method of claim 3, wherein the semiconductor substrate comprises a plurality of microelectronic devices formed on a front side thereof.

5. The method of claim 4, further comprising:
forming a plurality of contact formations on a back side of the semiconductor substrate; and
forming a plurality of conductors from at least one of the microelectronic devices on the front side of the substrate to the back side of the semiconductor substrate, each of the contact formations being electrically connected to a respective one of the conductors.

6. The method of claim 5, wherein the high energy electromagnetic radiation is laser light.

7. The method of claim 6, wherein the plurality of contact formations are solder bumps having a melting temperature above 220° C.

8. The method of claim 7, wherein the second thickness of the semiconductor substrate is less than 100 microns.

9. The method of claim 8, wherein the semiconductor substrate comprises at least one of gallium arsenide, gallium nitride, and silicon, and the support substrate comprises at least one of sapphire and quartz.

10. The method of claim 9, further comprising demounting the semiconductor substrate from the support substrate.

11. A method for forming a microelectronic assembly, comprising:
mounting a semiconductor substrate having a first thickness to a support substrate with a low temperature adhesive having a softening temperature below 160° C.;
thinning the semiconductor substrate from the first thickness to a second thickness, the second thickness being less than 100 microns;
forming a plurality of solder bumps on the semiconductor substrate, the solder bumps having a melting temperature above 220° C.; and
directing high energy electromagnetic radiation onto at least one of the contact formations for a period of time sufficient to raise the temperature of the at least one of the contact formations above 220° C. and maintain the temperature of at least a portion of the low temperature adhesive below 160° C.

12. The method of claim 11, wherein the high energy electromagnetic radiation is laser light.

13. The method of claim 12, wherein the period of time is less than 0.5 seconds.

14. The method of claim 13, wherein the semiconductor substrate comprises a plurality of microelectronic devices formed on a front side thereof, and further comprising forming a plurality of conductors from the microelectronic devices on the front side of the semiconductor substrate to a back side of the semiconductor substrate, the plurality of solder bumps being formed on the backside of the semiconductor substrate and each of the solder bumps being electrically connected to a respective one of the conductors.

15. The method of claim 14, wherein the semiconductor substrate comprises at least one of gallium arsenide, gallium nitride, and silicon, and the support substrate comprises at least one of sapphire and quartz.

16. A method for forming a microelectronic assembly, comprising:
mounting a semiconductor substrate to a support substrate with a low temperature adhesive having a softening temperature below 160° C., the semiconductor substrate having a top side, a back side, a first thickness, and a plurality of microelectronic devices formed on the top side, the top side of the semiconductor substrate being adjacent to the support substrate;
thinning the semiconductor substrate to a second thickness, the second thickness being less than 100 microns;
forming a plurality of vias through the back side of the semiconductor substrate to the microelectronic devices on the front side of the substrate;
forming a plurality of conductors from the microelectronic devices on the front side of the semiconductor substrate through the vias to the back side of the semiconductor substrate;
forming a plurality of solder bumps on the back side of the semiconductor substrate, the plurality of solder bumps each being electrically connected to a respective microelectronic device on the front side of the semiconductor substrate through a respective conductor, the solder bumps having a melting temperature above 220° C.;
directing laser light onto at least one of the solder bumps for a period of time less than 0.5 seconds to reflow the at least one of the solder bumps; and
demounting the semiconductor substrate from the support substrate.

16. The method of claim 15, wherein said direction of laser light raises the temperature of the at least one of the solder bumps above 220° C. and maintains the temperature of at least a portion of the low temperature adhesive below 160° C.

17. The method of claim 16, wherein the solder bumps comprise a lead-free solder material.

18. The method of claim 17, further comprising placing the semiconductor substrate on a refrigerated substrate support prior to said direction of laser light.

19. The method of claim 18, further comprising directing laser light onto a plurality of the solder bumps simultaneously.

20. The method of claim 19, wherein the semiconductor substrate comprises at least one of gallium arsenide, gallium nitride, and silicon, and the support substrate comprises at least one of sapphire and quartz.
